(19) United States
(12) Patent Application Publication
(10) Pub. No.: US 2022/0176594 A1
(43) Pub. Date: Jun. 9, 2022

(54) COMPOSITE BOARD FROM PLASTIC WASTE

(71) Applicants: Sissel Alexander Symon VIELFREUND, Tel Aviv (IL); Amit VIELFREUND, Bat Yam (IL); Tal David VIELFREUND, Bat Yam (IL)

(72) Inventor: Sissel Alexander Symon VIELFREUND, Tel Aviv (IL)

(73) Assignees: Sissel Alexander Symon VIELFREUND, Tel Aviv (IL); Amit VIELFREUND, Bat Yam (IL); Tal David VIELFREUND, Bat Yam (IL)

(21) Appl. No.: 17/604,421

(22) PCT Filed: Mar. 12, 2020
(86) PCT No.: PCT/IL2020/050296

§ 371 Date: Oct. 17, 2021

Related U.S. Application Data
(60) Provisional application No. 62/839,801, filed on Apr. 29, 2019.

(51) Int. Cl. B29B 17/00; B32B 7/022; B32B 37/14; B32B 5/16

(52) U.S. Cl. CPC B29B 17/0042; B32B 7/022; B32B 37/144; B32B 5/16; B32B 2272/00; B32B 2260/046; B32B 2264/305; B32B 2305/70; B32B 2250/03; B32B 2250/40; B32B 2260/025; B32B 2037/148

(57) ABSTRACT

Plastic waste is shredded and formed to a desired shape and held together using a binder and/or heat, etc. The resulting composite material may be useful for building and/or furniture and/or flooring, etc. (similar to wood composite board). In some embodiments, the board is highly water resistant. Optionally, the board is made of layers. For example, an inner layer has reduced density and/or an outer layer may have decreased particle size and/or increased fiber content.

### RELATED APPLICATION/S

This application claims the benefit of priority under 35 USC § 119(e) of U.S. Provisional Patent Application No. 62/839,801 filed May 29, 2019, the contents of which are incorporated herein by reference in their entirety.

### FIELD AND BACKGROUND OF THE INVENTION

The present invention relates to composite board. More particularly but not exclusively, the present invention relates to composite board created from plastic and/or other waste.

U.S. Pat. No. 7,757,974 appears to disclose, “A method for comminuting and cleaning waste or mixed plastic, the method comprising: producing a compacted material, comprising an agglomerate from film scraps or film remnants comminuted into flakes and/or thick-walled plastic parts chopped up into chips, introducing the compacted material into a disc or drum refiner and grinding in the presence of water . . . removing a fine grain fraction together with process water from the ground stock exiting from the refiner by separation with a sieve or a filter, washing the remaining ground stock and either mechanically dewatering and drying, or pulverizing in a further refiner stage in the presence of water, and subsequently dewatering and drying.”

US Patent 20100319144 appears to disclose, “Modular plastic structural composites having a web section disposed along a horizontal axis and at least one flange section disposed along a horizontal axis parallel thereto and integrally molded to engage the top or bottom surface of the web section, wherein said composite is formed from a mixture of (A) high density polyolefin and (B) a thermoplastic-coated fiber material, poly-styrene, or a combination thereof.”

German Patent DE102006033818 appears to disclose, “Producing building panels using recycled polyester and polyurethane plastic composites from construction- or automobile waste, shreds, screens, adds binder and water then compresses in mold.”

German Patent DE10330756 appears to disclose, “Fibrous material production for subsequent use with binder for pressing into panels involves mixing wood based fibers and particles with plastic fibers and particles recovered from recycled material.”

PCT Patent WO2016074053 appears to disclose, “Method for reusing solid waste from ordinary refuse rejected from conventional recycling processes and construction waste by mixing with a binding composite to make bricks or similar products, comprising a manufacturing concept in which the end product is bricks, tiles and other products of the same type and form, in which both solid waste (5) from ordinary industrial and non-industrial refuse and construction waste is reused, and primarily waste rejected from refuse recycling processes, the mechanical grinding (1) of expanded polystyrene (EPS) or equivalent cellular plastic material, the volume of which may be reduced (2) beforehand or afterwards using a common solvent, before the subsequent addition (3) of earth, water and/or slurry, in order to obtain a composite (1, 2, 3) that, when mixed with said waste (5), acts as a binding agent, effectively and advantageously replacing a cement binder or equivalent, for making bricks, tiles and blocks for paving and building.”

European Patent EP0334420 appears to disclose, “A process for the reuse of mixed thermoplastic materials recovered from industrial and/or solid urban waste for the purpose of manufacturing elements for the building industry, farming, or similar uses, in which there is no pre-selection or separation of the different thermoplastic materials even if they have diverse physical and chemical properties. Said materials are ground or pulverized then, by means of a series of processes including melting under vacuum conditions, a plastic mass suitable for the molding of different articles is obtained.”

Japanese Patent JPH11291248 appears to disclose, “A PP waste material is ground by a grinder 6 to obtain fine pieces having a size of about 1 cm² and a PP laminate waste material is also ground in the same way and a rubber waste material such as an old tire or the like is ground to be formed into a powder form. A material weighing and mixing supply apparatus 7 weighs these ground materials so that the rubber material becomes 80 wt. % and these materials are supplied to a mixer 8. The materials in a chamber are stirred and mixed by the high speed rotation of the stirring blades of the mixer 8 to melt a resin by internal frictional heat to form a gel-like mixed material. This material is formed into a panel shape by a press molding device 10 to obtain a building floor material.”

### SUMMARY OF THE INVENTION

According to an aspect of some embodiments of the invention, there is provided a method of creating a composite board including: collecting waste materials including at least 20% plastic; shredding the waste material; mixing the shredded waste material with a binder; heating the mixed waste material and binder to for a resin; molding the resin; and hardening the molded resin to form a composite board.

According to some embodiments of the invention, the method further includes: sorting the waste materials to include at least 80% plastic.

According to some embodiments of the invention, the composite board is of uniform.

According to some embodiments of the invention, the composite board is of a layered structure.

According to some embodiments of the invention, the composite board includes an inner layer of lower density than an outer layer.

According to some embodiments of the invention, the composite board includes an inner layer having an average particle size larger than an outer layer.

According to some embodiments of the invention, the composite board includes an outer layer having including a larger portion of fibers than an inner layer.

According to some embodiments of the invention, the composite board includes an inner layer sandwiched between two outer layers.

According to some embodiments of the invention, the composite board is uniform in their at least one of density, melting point, ductility, hardness, thermoplasticity, water resistance, structural strength and durability.

According to some embodiments of the invention, plastic and/or other waste are used to create panels of composite board that have a relatively high melting point, ductility, hardness, thermoplasticity, water resistance, structural strength and/or durability.

According to an aspect of some embodiments of the invention, there is provided a composite board including: plastic waste at least 50% by weight; and a binder of less than 50% by weigh.

According to some embodiments of the invention, the composite board is of a layered structure.

According to some embodiments of the invention, the composite board includes an inner layer of lower density than an outer layer.

According to some embodiments of the invention, the composite board includes an inner layer having an average particle size larger than an outer layer.

According to some embodiments of the invention, the composite board includes an outer layer having including a larger portion of fibers than an inner layer.

According to some embodiments of the invention, the composite board includes an inner layer sandwiched between two outer layers.

According to some embodiments of the invention, the composite board that is of uniform bulk physical makeup.

According to some embodiments of the invention, the bulk properties of the composite board are uniform in at least one bulk property selected from density, melting point, ductility, hardness, thermoplasticity, water resistance, structural strength and durability.

According to some embodiments of the invention, the composite board has at least bulk property of a relatively high melting point, ductility, hardness, thermoplasticity, water resistance, structural strength and durability.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a perspective view of a panel of composite structural material created from plastic waste in accordance with an embodiment of the present invention;

FIG. 2 is a sectional view, illustrating a composite structural material created in accordance with some embodiments of the present invention;

FIG. 3 is table illustrating the structural of a material created in accordance with some embodiments of the present invention; and

FIG. 4 is a flow chart illustration of a method of creating composite structural material in accordance with embodiments of the present invention.

### DESCRIPTION OF SPECIFIC EMBODIMENTS OF THE INVENTION

The present invention relates to composite board. More particularly but not exclusively, the present invention relates to composite board created from plastic and other waste. In some embodiments the composite structural material comprising the composite board is comprised of mostly plastic waste. Optionally, the composite structural material is created by shredding 403 plastic or other waste 401. Optionally, the shredded and/or non-shredded waste is ground into small or fine particles 404. Optionally, the small or fine particles and/or other forms of the waste are mixed with caulking material and/or binder in a blender 405. Optionally, the blended mixture is formed to a desired shape 409.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

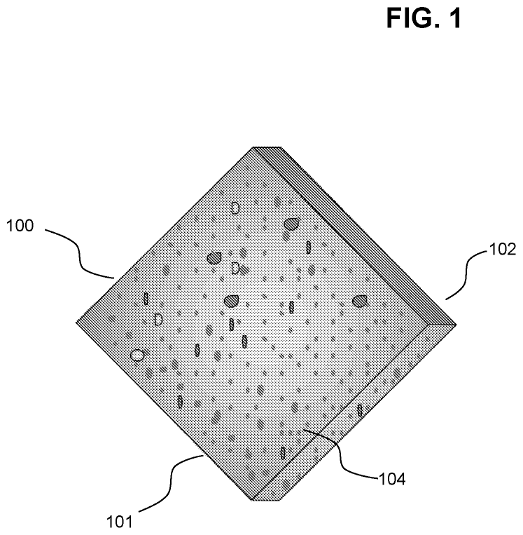

FIG. 1 is a perspective view of a panel of composite structural material created from plastic waste in accordance with an embodiment of the present invention. In some embodiments composite structural material may be mostly comprised of plastic granules 104, 203 which are mostly less than 1 mm in length. For example, more than more than 50% and/or more than 85% of the granules may be slightly less than 1 mm in length. Optionally, the other 15% to 50% of the granules may be between 1 mm and 3 mms in length. Alternatively or additionally, composite structural material may be partially comprised of fibers 204. For example, the average size of particles may range between 0 to 0.5 mm and/or between 0.5 to 1 mm and/or between 1 to 3 mm and/or between 3 to 10 mm. Optionally the standard deviation in size may range between 0 to 1 and/or between 1 to 2 and/or between 2 to 3 and/or between 3 to 5. Optionally some or all of the particles may be anisotropic. For example, between 0 to 30% and/or between 30 to 60% and/or between 60 to 100% of the particles may have an anisotropy ratio of greater than 1.2 and/or greater than 1.5 and/or greater than 2. For example, the size and shape of the particles may be varied to control the density and/or strength and/or elasticity and/or heat resistance and/or fire resistance, of the resulting product. For example, larger particles and/or less densely packed particles may produce a lighter panel. For example, higher heterogeneity of particular size may produce a stronger panel. For example, smaller particles may be used for thinner and/or denser panels.

In some embodiments the small or fine particles 404 and/or other forms of the waste are mixed with silicone. Optionally, the mixture is blended e.g. in a blender comprising a vessel and rotating blades. Optionally, the mixture of waste materials is heated, for example, by the rotation of the stirring blades 405 of the blender resulting in a resin that is gel-like or viscous 408.

In some embodiments waste which does not become gel-like or viscous after being stirred is filtered from the mixture, separated and shredded, ground and/or blended or mixed an additional time. Alternatively or additionally, the subsequent grinding creates smaller particles than the previous grinding. Alternatively or additionally, the subsequent mixing is carried out at a higher temperature than the previous mixing. Alternatively or additionally, this process may be repeated multiple times 407.

In some embodiments the resin resulting from the blending of the composite structural material may be placed in a mold in order to create panels of uniform size. For example, the molds may be designed to create panels in which the length 100 could be 30 cm to 50 cm and/or 5 cm to 150 cm. The width 101 of the panels could be 30 cm to 50 cm and/or 5 cm to 150 cm. The height 102 of the panels could be 1 cm to 2 cm and/or 0.5 cm to 10 cm. The width and length of the panels could be equal. Alternatively or additionally, the width and length of the panels could differ.

In some embodiments the resin resulting from the blending of the composite structural material may be subjected to pressure while in a mold in order to hasten the process of drying and/or hardening the material 411. Optionally, the pressure may increase the density of the composite structural material. For example, the resin may initially reach a height greater than the height of the mold and then be pressed down to exactly the height of the mold. For example, the resin placed in a mold with a height of 2 cm may have a height itself that is greater than 2 cm and then be pressed down to be exactly 2 cm in height across the entire length and width of the mold. Optionally, the composite structural material may be pressed with approximately 20 kg of force from a bed of hard material lying above the mold until the binder is dried and/or hardened. For example, a sheet of metal 410 may be used as the bed of hard material pressing down on the resin. The pressure on the material optionally ranges between 1 to 10 kg/m² and/or between 10 to 30 kg/m² and/or between 30 to 100 kg/m² and/or 100 to 500 kg/m².

Optionally, the dried and/or hardened composite board is comprised of granules 411.

Optionally, composite structural material may include sorted, unsorted and/or substantially unsorted waste. For example, the composite structural material may be formed from unsorted industrial and/or domestic waste. Optionally, the waste may be sorted to remove only organic waste and/or toxic waste 402. For example, 100% or close to 100% (e.g. more than 80% and/or more than 50%) of waste from a particular landfill, garbage truck or commercial or domestic waste container may be used in the formation of the composite structural material. Alternatively or additionally, a percentage of waste from a particular landfill, garbage truck or commercial or domestic waste container that is higher than the industry standard for percentage of recycled waste may be used in the formation of the composite structural material.

In some embodiments, the formation of composite structural material through the use of a percentage of waste that is higher than the industry standard for percentage of waste used in recycling processes may result in a process that is more cost effective than current systems for recycling waste.

Alternatively or additionally, the composite structural material may include plastic, rubber, metal, wood, glass and/or other waste. For example, the rubber and/or tire cord fabric of waste automobile tires may be included in the materials grinded together to form the composite structural material. Alternatively or additionally, non-vulcanized rubber may be included. Optionally, other particles may be added for example, silicone, sand, quartz, bamboo. Optionally water-resistant materials are chosen. Optionally, the type of binder may be selected to control the density and/or strength and/or elasticity of the resulting product and/or heat resistance and/or fire resistance of the resulting product.

In some embodiments a weighing apparatus is used to adjust the mixture to a predetermined percentage of various components of the mixture before they are added to the blender. For example, rubber material may be added to the blender in an amount that ensures that it is approximately 75% of the weight of the components of the structural material before the addition of caulking material and/or binder. For example, a silicone binder may be used and/or an organic binder and/or another resin and/or other binding materials. Optionally, the composite board may include by weight between 0 to 10% binder and/or between 10 to 30% binder and/or between 30 to 60% binder.

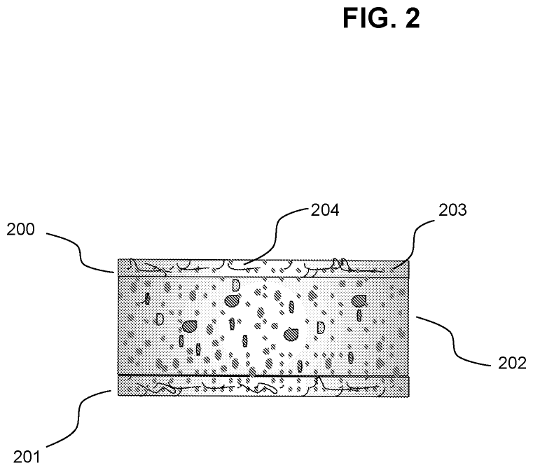

FIG. 2 is a sectional view of a panel of composite board, on an enlarged scale, illustrating the specific arrangement of the components forming the composite structural material created in accordance with embodiments of the present invention.

In some embodiments the panels of composite structural material are uniform in their physical makeup and/or their physical properties. For example, the panels may be of uniform weight, melting point, ductility, hardness, thermoplasticity, water resistance, structural strength and/or durability, etc. Optionally, the panels may have a melting point, ductility, hardness, thermoplasticity, water resistance and/or durability that are relatively high for composite structural material.

Alternatively or additionally, the outer layer of the panels of composite structural material may possess physical properties that are different from the inner layer of the panels. For example, the outer layer 200, 201 may be harder and/or more water resistant than the inner layer 202 of the panels. Optionally, the outer layers 200, 201 may contain granules 203 in greater density than the inner layer 202 of the panels. Alternatively or additionally, the outer layers 200, 201 may contain fiber 204 in greater density than the inner layer 202 of the panels.

In some embodiments, an outer layer may include a different material. For example, a plastic composite board may be covered with a decorative covering (for example Formica) and or as a backing for a flooring produce (similar to linoleum, but with a water resistant plastic composite backing). For example, the combination may be used as a decorative tile and/or for kitchen closets (e.g. as a waterproof composite board).

In some embodiments, the composite board may be formed into various shapes. For example, a shape may have three dimensional features. For example, a plastic composite may be formed into a sink and/or a bath tub.

In some embodiments the composite boards are sufficiently water resistant to be used as walls in bathrooms and/or in the walls, and/or doors, and/or door frames of bathroom, kitchen and/or utility room. The material may be used as sinks, as countertops in bathrooms, kitchens and/or utility rooms, as flooring near pools, as outdoor flooring, as deck flooring, and/or as flooring and as walls in pool changing rooms 412. Alternatively or additionally, the composite board may be used on other surfaces in which water resistance is necessary and/or helpful.

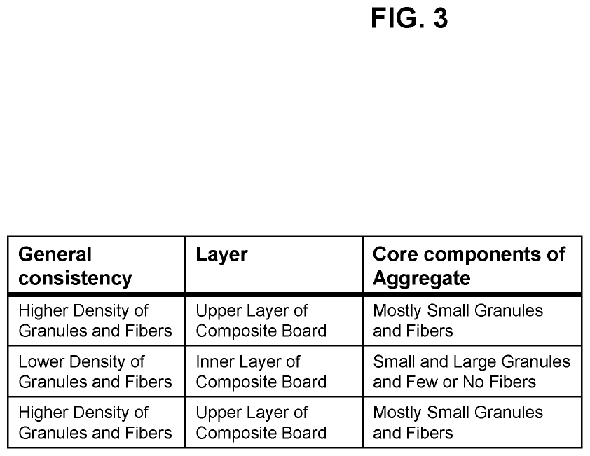

FIG. 3 is a block diagram illustrating the relationship between the aggregate, the core, the fibers and the binder of composite structural material created in accordance with embodiments of the present invention.

In some embodiments the panels of composite structural material are uniform in their distribution of some components of the structural material. For example, binder may be evenly distributed between the inner and outer layers of the composite board.

Alternatively or additionally, the outer layers of the panels of composite structural material may possess some components of the structural material. For example, the outer layers may have a higher density of granules and fibers than the inner layer of the panels. Optionally, the core components of the aggregate may differ between layers. For example, the outer layers may be comprised mostly of small granules and fibers while the inner layer of the panels may be comprised of both small and large granules. Alternatively or additionally, the inner layer of the panels may be comprised of few or no fibers.

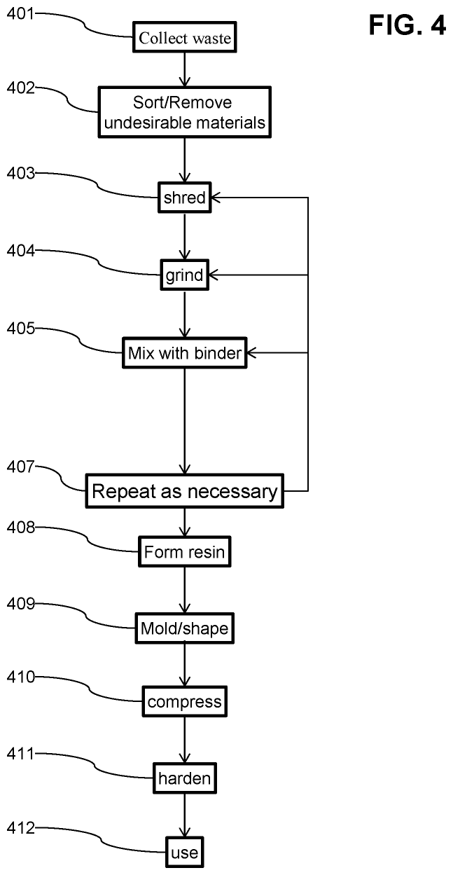

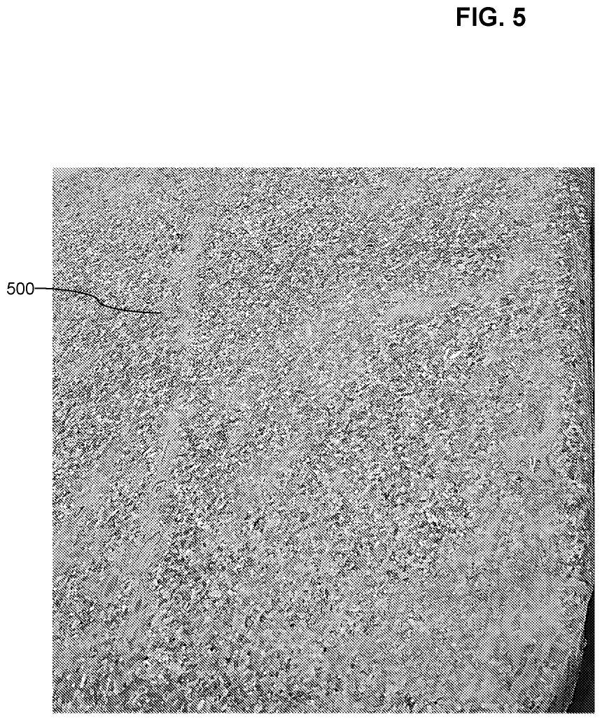

FIG. 4 is a flow chart illustration of optional steps in a method of creating composite structural material in accordance with embodiments of the present invention. Optionally, waste is collected 401. The waste may consist of, for example, plastic, rubber, metal, wood, glass and/or other types of waste are collected from sorted and/or unsorted industrial and/or domestic waste from a landfill, garbage truck, commercial or domestic waste container and/or other location of waste.

In some embodiments, the waste is sorted 402. For example, organic waste and/or toxic waste may be removed therefrom. Optionally, plastic and other waste amenable to shredding are shredded 403. In some embodiments, the shredded waste and/or unshredded waste may be ground 404 into small and/or fine particles.

In some embodiments, raw waste materials, shredded waste and/or ground waste are mixed 405 (for example, in a blender) together with a binding material (for example silicone and/or caulking material and/or a binding agent).

In some embodiments, the mixture is activated, for example, by heating while stirring and/or by means of a chemical agent and/or exposure to air and/or light etc. The heat and/or mixing action optionally transform 407 the mixture into a gel-like or viscous resin. Optionally, shredding 403, grinding 404 and/or mixing 405 and/or activation are repeated 407 as necessary.

The resin is optionally molded 409. For example, the resin may be placed in a mold for example, to create a composite board panel of a specific shape. The material is optionally compressed 410 while it is molded 409 and/or hardened 411. For example, a sheet of metal may be pressed down onto the resin while it rests in the mold.

In some embodiments, the resin is dried and/or hardened into a composite board panels comprised of small granules. The composite board panels are used 412, for example, in the construction of walls, counter tops, flooring and other structures.

In some embodiments, bulk properties of the board may include a melting point of greater than 200 C and/or greater than 1000 C. and/or. In some embodiments, a composite board may have Brill hardness ranging between 0.1 to 0.5 HBS and/or 0.5 to 1 HBS and/or between 1 to 2 HBS and/or between 2 to 5 HBS and/or between 5 to 10 HBS and/or between 10 to 20 HBS and/or between 20 to 50 HBS. In some embodiments, a composite board may have a density ranging between 100 to 400 kg/m³ and/or between 400 to 600 kg/m³ and/or between 600 to 800 kg/m³ and/or between 800 to 1200 kg/m³ and/or between 1200 to 1500 kg/m³ and/or between 1500 to 3000 kg/m³

Various embodiments and aspects of the present invention as delineated hereinabove and as claimed in the claims section below find support in the following example.

### Example

Reference is now made to the following examples, which together with the above descriptions illustrate some embodiments of the invention in a non limiting fashion.

FIG. 5 illustrates a board 500 that is approximately 40 cm by 40 cm and 2 cm thick. The board was made by grinding garbage (mostly plastic waste) and silicon binder (e.g. caulking compound) in a blender placing the resulting resin in a mold and pressing it under about 20 kg force until the binder hardened. The plastic granules were mostly less than 1 mm and the board was hard and waterproof. The garbage included plastic, rubber (e.g. old tires) and some metal wood and/or glass waste.

It is expected that during the life of a patent maturing from this application many relevant technologies will be developed and the scope of the terms is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of creating a composite board comprising:
collecting waste materials including at least 50% plastic;
shredding the waste material;
mixing the shredded waste material with a binder to form a resin;
molding the resin; and
hardening the molded resin to form a composite board.

2. The method of claim 1, further comprising:
compressing said resin.

3. The method of claim 1, further comprising:
sorting the waste materials to include at least 80% plastic.

4. The method of claim 1, wherein the composite board is of uniform.

5. The method of claim 1, wherein the composite board is of a layered structure.

6. The method of claim 5, wherein the composite board includes an inner layer of lower density than an outer layer.

7. The method of claim 5, wherein the composite board includes an inner layer having an average particle size larger than an outer layer.

8. The method of claim 5, wherein the composite board includes an outer layer having including a larger portion of fibers than an inner layer.

9. The method of claim 5, wherein the composite board includes an inner layer sandwiched between two outer layers.

10. The method of claim 1 wherein the composite board is uniform in their at least one of density, melting point, ductility, hardness, thermoplasticity, water resistance, structural strength and durability.

11. The method of claim 1 wherein plastic and/or other waste are used to create panels of composite board that have a relatively high melting point, ductility, hardness, thermoplasticity, water resistance, structural strength and/or durability.

12. A composite board comprising:
plastic waste at least 50% by weight; and
a binder of less than 50% by weigh.

13. The composite board of claim 12, wherein the composite board is of a layered structure.

14. The composite board of claim 13, wherein the composite board includes an inner layer of lower density than an outer layer.

15. The composite board of claim 13, wherein the composite board includes an inner layer having an average particle size larger than an outer layer.

16. The composite board of claim 13, wherein the composite board includes an outer layer having including a larger portion of fibers than an inner layer.

17. The composite board of claim 13, wherein the composite board includes an inner layer sandwiched between two outer layers.

18. The composite board of claim 12 wherein the composite board that is of uniform bulk physical makeup.

19. The composite board of claim 12 wherein bulk properties of the composite board are uniform in at least one bulk property selected from density, melting point, ductility, hardness, thermoplasticity, water resistance, structural strength and durability.

20. The composite board of claim 12, having at least bulk property of a relatively high melting point, ductility, hardness, thermoplasticity, water resistance, structural strength and durability.
